(19) United States
(12) Patent Application Publication
(10) Pub. No.: US 2010/0076847 A1
(43) Pub. Date: Mar. 25, 2010

(54) Internet Marketing Method

(76) Inventor: Robert Heller, Valencia, CA (US)

Correspondence Address: Law Office of Ronald Shea, P.O. Box 5584, Sherman Oaks, CA, 91413, US

(21) Appl. No.: 12/505,252

(22) Filed: Jul. 17, 2009

Related U.S. Application Data
(60) Provisional application No. 61/081,551, filed on Jul. 17, 2008.

(51) Int. Cl. G06Q 30/00; G06F 3/048; G06F 17/30

(52) U.S. Cl. 705/14.53; 715/810; 707/706; 707/E17.108

(57) ABSTRACT

Internet clients submit a list of goods, services, or topics to an internet host, and specific URL addresses correlating to each good, service, or topic. The host presents a series of questions to participating users, wherein the answers are regarded as identifying potential user interests. The answers to the questions may be preference based, describing general categories of goods and services, or specific good and services of potential interest to a user. Alternatively, the answers may be skill dependent, wherein a user can accumulate points or some other reward tokens in response to a correct answer. The skill based questions are also used to identify areas of interest of the Internet user. After answering at least two questions, a user may be redirected to a specific web site or presented a list of potentially relevant web sites and links, or targeted for advertising. The Internet client pays the host a fee for inclusion of the client's URL site in the redirect pool. The fee may be a general fee, per user click, per user purchase, or combinations thereof.

### CROSS-REFERENCE TO RELATED APPLICATIONS

This application claims priority from, and incorporates by reference, U.S. Provisional Patent Application No. 61/081,551, filed on Jul. 17, 2008 by Robert Heller, and entitled “Checkpoint.” U.S. Provisional Patent Application No. 61/081,551 is incorporated by reference herein in its entirety.

### BACKGROUND OF THE INVENTION

1. Field of the Invention

This invention relates to the field of Internet marketing. More specifically, the present invention is related to a method for matching or prequalifying potential customers with a particular URL site (web site) or a good or service associated with a URL site.

2. Description of Related Art

Several methods are currently utilized by companies in order to drive internet users to specific web sites to build traffic to that site and, “hopefully”, provide a steady stream of prospective customers. The first method relies on a search engine to direct traffic to a website. In such applications, there are several goals of the seller. The first is to seed their URL site (“web site”) with visible text relating to likely search terms, and embedded text (not appearing on the computer screen of the average web surfer, and known, among other terms, as meta-tags) that also anticipated search terms by a consumer, and which are selected to result in the highest statistical correlation of consumer interest in the goods or services offered from that web site. A second, and related goal search engine based marketing is to select search terms that a consumer is likely to use. For example, a thirty-digit model number of an AC to DC power converter for a computer would have a very high statistical correlation of interest, since any consumer submitting such a search term would have a very specific product in mind. But it is also unlikely that the consumer would use a model number or part number. So the likelihood of a consumer using a specific search term is also important.

A third goal of a marketer or web designer utilizing search engine technology is to manage their presence on the internet such that, in the event of a match by a search engine, the link, URL site, etc of the seller is highly ranked by the search engine. A search may produce many “pages” (many computer screen displays) of search results, with the default page presented by the search engine numbered as page “1.” The higher “rank” in a search thereby corresponds with the lower page number. Moreover, a search “rank” corresponds with position of a link or search result on a page. Search results on a computer screen are typically displayed in a single vertical array, with the highest vertically positioned search result on a page being the “highest” or “best” or preferred position or highest ranked search result on the page. The whole issue of search engine placement is most commonly referred to as “Search Engine Optimization”. The optimization of a URL site, however, is primarily dependent on the skill of a programmer, versed in search engine optimization and keyword analysis, to gain a high ranking. In traditional search engine technology, the actual relevance a URL site has to the interests of the consumer has a minimal effect at best on the ranking of a web site in a search result.

A second approach to developing web site traffic that is in common use is to have an advertisement appear on a prospective customer's screen, either as a “pop-up” advertisement, or a static display at the side of a page. An ad. may include photographs, pictures, icons, text, sound, moving pictures and one or more URL hyperlinks. Typically, a URL hyperlink is integrally coupled with text or images on a computer screen in an advertisement. Advertisers can purchase “space” on third party web sites for their ads to appear. Usually, this is done on a fee per click-through basis, but may also be charged through other methods including per appearance (per viewer).

Targeted advertising typically involves the acquisition of information about a web client, a statistical analysis of that information, an identification of one or more products that produce the highest statistical correlation for a consumer response, and the display of an advertisement (“ad”) on the user's computer as described in the second advertising approach. Internet advertising, as with most traditional advertising methods, is passive in that it requires the user's computer user to actively select to go to the advertiser's web site. In this form of targeted advertising, a user is “passive” in the process of information gathering. For example, an “adware” program or application may be downloaded into a user's computer with or without the user's knowledge or consent. The adware application observes the internet history of a particular computer, and either transmits this history to a central server, or analyzes the data within the user's computer.

In addition to adware, data collection for analysis may be retrieved by other means. For example, an internet entity may provide free e-mail service. As a result, any e-mail sent by an internet user through a particular e-mail account passes through servers of the e-mail service provider. The contents of the e-mails can then be analyzed by various algorithms. The e-mail service provider will attempt to develop algorithms that generate a statistical correlation of consumer interest between various goods and services offered over the web, and terms or phrases that appear within the e-mail of users. In a similar vein some email providers provide spell checkers that are remotely accessible services and they, too, will scan emails being spell-checked and build an analysis of the spell check user's interests.

The correlation may be based on presuppositions of the programmer (e.g., if the words “mountain” and “bike” appear within two words of each other, the likelihood that the internet user may be interested in mountain bikes (or goods or services relating thereto, such as equipment, food, locations, etc.) is recorded as an increased correlation. This may be a simple flag bit in a category of a particular good or service relating to mountain bikes, or may be a cumulative score that progresses for various goods and services over the life of the e-mail account as keywords are repeated in the e-mails of the user.

Alternatively, the correlations drawn from an examination of e-mails may be based on artificial intelligence or other “learning” programs which first generate statistical correlates between various terms and various products. For example, an algorithm may simply analyze the e-mails of a million users, analyze the web sites visited by those users, compare these terms with the record of the web sites which each of those computers visited, and develop mathematical correlations therefrom. In this example, terms that are less intuitively related to mountain biking may be determined to be statistically significant when raw number crunching is performed on the e-mail of millions of internet users. After determining statistical correlates, specific high-probability users can be targeted for advertising of specific products.

In adware and e-mail type models, the user is passive in the collection of the data—i.e, the user is not intentionally providing the data collector with information about him/herself—and, even once the ‘most relevant’ ad. has been selected and displayed to the user, the user must make an active selection to visit the advertiser's web site. Statistical correlations are performed on a user's actions (web sites visited, terms used, etc.). However, a user does not respond to inquiries or otherwise interact with the algorithms performing such statistical correlations and targeted advertising. As a consequence, these methods must wait for a user to use certain key terms or visit a variety of web sites before they can predict what goods or services may hold interest to that Internet user. Adware has become so intrusive that many strategies, including software applications, have been developed to limit the ability of adware to surreptitiously acquire information from the unsuspecting internet user.

Another internet marketing model uses dishonest pop-up ads to “fish” for personal data about Internet users. A pop-up ad may say, “You have been selected to win a computer. Click here to claim your prize.” In these models, the user actually interacts with an online questionnaire or program. When the user clicks on the link, he or she is typically directed to fill out a brief questionnaire. The questionnaire will typically include a requirement that the “winner” first provide a legitimate e-mail address. This can be sold an unlimited number of times to “spam merchants” who blindly e-mail Internet users with an offer of a good or service. An Internet user who begins to fill in an online data form to claim his new prize may subsequently find his or her e-mail in-box inundated with spam. If the questionnaire requires more data than simply a e-mail address, it will typically spread the online form over multiple screen shots, thereby disguising the extent of the questionnaire. This leads to a more benign appearance of the questionnaire, and also a less daunting appearance. To keep the user from surfing away from the questionnaire, the submission of data from a screen shot will typically result in an announcement that the user is “almost through,” and that there are “just a few more questions.” Such assurances are necessary to prevent the Internet user from aborting the process.

Whether any person in the history of the world has ever claimed their “free computer” by this process is unknown. However, such techniques suffer several drawbacks. Firstly, they are usually dishonest. Secondly, the information solicited by such a pop-up ad does little or nothing to match Internet users with some specific good, services, or information URL in a way that increases the statistical likelihood of a “hit” on that web site, or a purchase. The information typically generates massive databases of e-mail addresses which can be sold to spammers who seek to sell goods or services by the raw number of e-mails sent out. Thirdly, the filling out of such online data forms is generally not perceived by an Internet user as a pleasurable activity. It is an annoying duty that the Internet user must perform to claim a prize. As a consequence, the more data that is solicited, the more likely that the user will become annoyed with the questionnaire. This annoyance is amplified to whatever extent the Internet user believes that the pop-up ad has been dishonest or manipulative in its solicitation of information. The more annoyed the Internet user, the more likely they will abort the process, or worse, provide inaccurate information. Additionally, pop-up advertising has become such a nuisance that most internet browsers have one or more layers of pop-up blockers.

There remains therefore a need, in an internet environment, for a method of eliciting Internet user interaction via computer interface in the generation of statistical correlates between different Internet users and their likelihood of interest in a particular good or service. There remains further a need for eliciting information from an internet user in a manner that does not make deceptive offers or promises to the Internet user. Furthermore, there is a need for a method of eliciting information from an internet user in a manner that is not annoying to the Internet user. There further remains a need for an improved way to drive Internet users to a URL site, rather than relying on the tired ‘advertising’ model in an increasingly information cluttered environment. There is a further need for a redirect algorithm that replaces the “seller” driven search engine (optimized by the seller), with buyer driven search engines, optimized by the expressed preferences and decisions of an Internet user.

### SUMMARY OF THE INVENTION

The present invention describes a method, in an internet environment, of eliciting Internet user interaction via computer interface in the generation of statistical correlates between different Internet users and their likelihood of interest in a particular good or service. The present invention also describes a redirect algorithm which, in an internet environment, replaces the “seller” driven search engine (optimized by the seller), with buyer driven search engines, wherein the “ranking” of web sites is optimized, inter alia, by the expressed preferences and decisions of an Internet user.

The present invention is directed at a method to elicit information from an internet user, analyze the data through a host algorithm and indentify web sites which appear relevant to the needs or interests of the user. This process is followed by one or more of the following actions: a) automatically delivering a user directly to a specific page on a website as identified by the host algorithm; b) displaying a variety of potential web sites or URL links on the screen of a user, wherein those web sites or URL links that appear to be relevant to the user's interests, c) target advertising to the user's computer based on the analysis of the data collected by the host algorithm at various points in the interaction between the host provider and the Internet user, d) improve the web site's search engine ranking in traditional search engines through the volume of traffic directed thereto, e) continually improving the rate of a successful redirect of a consumer to a web site, wherein success is measured in the satisfaction an Internet user experiences with a web site in terms of meeting specific needs or requests of the Internet user, f) utilizing a “learning engine” or artificial intelligence program to modify the statistical correlation between web sites recommended by a search engine, and the questions/answers/search terms presented by a user f) improving Internet user satisfaction with the end result of their search compared with traditional search engines; and g) facilitate the transfer of specific knowledge about a good or service offered by a web site company to a prospective customer that has been determined to be of likely interest to that prospective customer (Internet user) and h) direct the contestant to a non-Internet based business, location or other real-world entity including, but not limited to, a radio station, magazine, newspaper, TV or movie, hairdresser, grocery store or car sales.

### DETAILED DESCRIPTION

The novel features which are considered characteristic for the invention are set forth in the detailed description and the appended claims. The invention itself, however, both as to its construction and its method of operation, together with additional objects and advantages thereof, will be best understood from the following description of the specific embodiments when read and understood in connection with the accompanying drawing(s). The underlying concept of the present invention is related to a method for prequalifying potential customers with respect to a good or service associated with a URL site (web site) through a competitive contest such as a series of challenges or questions testing the skill or knowledge of the participant. The skill testing questions, or challenges, are placed into categories and, as the contestant selects which categories he/she wishes to participate in the contestant is beginning the process of providing ‘area of interest’ information to the contest provider service. Further, the responses by any particular participant are used to create a more detailed profile of that participant. That user profile is analyzed to identify statistical correlates that indicate the probable level of interest by the user (competitor) to various goods or services represented on various URL sites. The identification of one or more statistical correlates in which the participant may be interested triggers one or more events, including, but not limited to, redirecting the contestant to a particular URL site, providing hyperlinks to a URL site, directing targeted advertising to a web site which the contestant is currently viewing, providing feedback on the contestant's performance (such as aggregate score, contestant rank, etc.) and providing a means of contacting other contestants. Throughout this disclosure, the terms “user,” “Internet user,” “participant” and “contestant,” are used to refer to an individual internet user, unless the context plainly states otherwise. The term “host,” and terms derived therefrom (such as “host algorithm,” “gaming host,” “contest host” “competition host” or “search host”) refer to the entity that is providing the contest or questions, performing the statistical interpretation of the data derived therefrom, and directing the user to an appropriate web site. “Teams” are comprised of two or more participating contestants. A “client” refers to an entity behind (sponsoring) a web site at a particular URL address to sell goods or services, provide information, or otherwise make its web site available for public use. A “participating client” is a client that has paid or is paying a fee to the host in order to be incorporated into the host data base as a target web site to an Internet user utilizing the host's services. Further, any reference to “web site” or URL site may also be construed to refer to a real-world “bricks and mortar” location or entity including, but not limited to, a radio broadcast, TV channel, movie, newspaper, magazine, retail or wholesale outlet, professional services office etc.

Throughout this disclosure, clients are frequently described as representing goods or services on their web site. However, it is understood that many web sites have little or no commercial interest, and are primarily informational. Examples of informational web sites would include, for example, web sites describing the reign of Emperor Charlemagne, the theology of John Calvin, the behavior of an electric field in a dielectric, etc. For verbal brevity, many of the specific examples are described in terms of a client web site offering goods or services. These examples are not intended to limit the spirit and scope of the appended claims, which include goods, services, and informational web sites. Similarly, the term “transact” is used in the broadest sense. A transaction may include a commercial transaction. However, the downloading of information from an informational web site, or the use of a “dollar to euro” conversion module on an informational web site are envisioned within the scope of the term “transaction” unless otherwise prohibited by the language of a claim.

A feature of the embodiments disclosed herein includes the use of questions to drive Internet users to URL sites, which questions may, or may not be, directly related to the good or service offered by the target URL site, or real-world entity, thereby is the initial goal in increasing web traffic is to first attract a participant to participate in a knowledge or skill testing contest, or otherwise answer one or more questions that are designed to more specifically identify the interest of the Internet user, and redirect the Internet user to the appropriate web site. The questions or challenges are designed to identify Internet users that would have a higher likelihood of interest in a particular good or service, or to match Internet users to a particular good or service when they are searching for some particular good or service. The host utilizes digitally executed algorithms to maximize likelihood the interest of a user in some particular good or service. The more sophisticated the algorithm for analyzing the data, the higher the statistical correlations that can be achieved with web sites indicated by targeted advertising or redirect procedures, and the user interest and in that particular web site (or a good or service provided on a web site). Statistical correlation can be measured by a variety of metrics, but two of the most common are: 1) the probability that an Internet user will select a link to access a proposed web site or respond to an ad (click on an ad), and, 2) the probability that an Internet user will ultimately transact a purchase from the entity displaying the ad. Probability can be single event, or cumulative. A cumulative model assumes that a probability of Internet user response is not linear—equal every time an ad appears, but non-linear, such that the probability of a favorable Internet user response to an individual ad on a particular screen display is greater after multiple screen displays than it was on the first.

There are three distinct embodiments of the present invention, variously referred to herein as “contest embodiment” the “search embodiment” and the “targeted advertising embodiment.” Although these embodiments are discussed in greater detail below, a brief discussion of these embodiments at this point will simplify the understanding of subsequent paragraphs.

A contest embodiment would involve the accumulation of tokens for correct answers. The tokens may simply be numerical point values, but may also include more complex awards, such as an “extra turn” or a new or improved gaming tool (much as one trades in a pawn for a more powerful piece in chess if one reaches the opponents back row). A contest embodiment may include multiple contestants who compete against each other. Alternatively, a contest embodiment may include a single contestant competing against himself, in much the same manner that a pinball game frequently involves a single player trying to maximize his or her performance.

In a search embodiment, the accumulation of points is not used to entice user participation. Rather, a user initiates the processes described herein with a specific search goal on the internet. The search embodiment has certain similarities to the use of contemporary “search engines” to locate web pages, or products, services or information described therein. However, the search embodiment incorporates novel features described herein, such as answering one or more multiple choice questions as part of the process of identifying useful web sites, or redirecting the Internet user to a suitable web site. A distinction between multiple choice questions in the search embodiment and multiple choice questions in the contest embodiment is that questions in the contest embodiment will typically have “right answers” and “wrong answers,” whereas multiple choice questions in the search embodiment are not used for the accumulation of “points” or tokens on the basis of “right or wrong.” Rather, multiple choice answers in a search embodiment will typically be directed to goods or services that are a specie or subset of previous answers. A selection of an answer may introduce a new question, or offer one or more links to web sites relating to that answer.

A targeted advertising embodiment compiles data relating to the answers provided by a contestant, and presents offers to the contestant based on an analysis of that data. An offer may be an advertisement for a specific product or web site, or an offer to participate in a question or sequence of questions. The question, or sequence of questions my be related to the search embodiment, or the contest embodiment. As a consequence, the targeted advertising embodiment may be a precursor or of the search embodiment, or the contest embodiment. The offers may be in the form of e-mails, “pop-up” offers, “static” adds on the host web site, or in invitation on a permanent (or semi-permanent) host tool bar displayed on a web browser. Although many examples described below are in terms of one of these particular embodiment (the contest, search, and targeted advertising embodiments), this is done only for brevity. Where applicable, the processes and steps described herein can be used with a contest embodiment, search embodiment, or targeted advertising embodiments.

In a “contest embodiment,” for example, an avid rock or mountain climber would be more likely to know the names of the highest mountain peaks in North America than an avid stamp collector. Such a contestant might reasonably be expected to select to answer skill testing questions from a category “North American Mountain Ranges”, rather than a category “Stamps Of The World”. A first question, therefore, might be directed to the name, location or height of the highest mountain peaks in North America. A test question, therefore, which was directed to this subject would be somewhat able to distinguish between more and less avid mountain climbers. In this form (skill and knowledge based testing), the application is directed more toward inducing an Internet user to engage in a contest, with the end purpose of redirecting the Internet user to an appropriate web site that would provide goods and/or services that would be of interest to that contestant—for example, a back packing equipment provider. A contest embodiment could be initiated in a number of ways. A contestant could access the host web site, and click on an icon configured to initiate a contest, or incorporate the user into an existing contest. Alternatively, the host could initiate contests through pop-up offers, a static tool bar which announces a contest, etc. The first round of a contest embodiment may begin with a text submission to a search field, as commonly done in prior art search engines. However, a contest can begin by other steps as well. A contest may begin with a single question or single category of questions being presented to a contestant. Alternatively, the first round of a competition may begin with plurality of questions and/or categories, allowing the user to select the starting point. The categories of questions may be fixed, such as the categories used for classification of patent applications by the USPTO or the international searching authority. Categories dealing with knowledge and information (rather than commercial transaction) are also stored within the host data base. Categories may be nested within categories. For example, a first category choice could be a letter of the alphabet. Under the letter “E” any number of categories may be listed, including “electronic equipment.” Under electronic equipment, there again may be any number of relevant categories and terms. A “root term” is a term which, if selected, will either initialize a redirect command to a relevant web site, or initialize a screen display of relevant URL links (web site links). Root terms and categories may appear within the same list. A marker, such as color, capital letters, bold face, etc. is preferably used may be used to distinguish terms marking a new sub-category from root terms.

In a “search embodiment,” an Internet user would begin searching for some specific good or service, and the host would present a series of questions to better understand the exact nature of the Internet user's search. The specifics of the “contest embodiments” and “search embodiments” are discussed further below. The search embodiment distinguished from the contest embodiment in that it is not initiated by the host, but only by the user. As in the contest embodiment, the first round of a search embodiment may begin with a text submission to a search field, as commonly done in prior art search engines, or by a user selecting a search category from a menu of available products, services, and information available on the web. Alternatively, as discussed above in conjunction with the contest embodiment, the user may initiate a search by selecting from a menu offering a variety of available categories, such as the categories used for classification of patent applications by the USPTO or the international searching authority. However, a “search embodiment” will not begin with a predetermined question, or a question from a predetermined category or a limited chose of categories.

In the targeted advertisement embodiment, the host initiates in invitation to the computer of a user. This may be in the form of an e-mail with a URL link, a pop-up add, or a “flag” or notice on a menu bar of the user. The initial question or available categories of questions presented in a targeted advertisement embodiment are preselected by the host. The selection is preferably done according to an analysis of data relating to a user, with question selection or category selection executed with a view toward maximizing user interest.

According to an embodiment, respective users would register prior to executing a search, or participating in a contest. The registration process would solicit an initial body of information that, when analyzed in conjunction with future contest participation habits, and answers, might enhance the statistical accuracy of the pre-qualification process. Registration could include any standard demographic information, including, but not limited to, age, sex, education level and fields of study, degrees held (and the specific disciplines), geographic location, ethnicity, etc. In an embodiment, a contestant would register once, and have a permanent “user ID” assigned for future contests, thereby obviating the need to repeatedly register and facilitating deeper analysis of that contestants interest and needs. In an alternative embodiment, a player would be required to register each time he played a “game” (also referred to herein as a “test” or “contest”).

Each contest can consist of a single question or challenge, but preferably consists of multiple questions. The answers may include multiple choice, text boxes, and any other means of interaction from a computer to an internet host. As described in the example below comparing two universities, embodiments are envisioned wherein multiple questions and there respective answers appear on a same page, and a submission of an answer is not permitted until all of the questions are answered.

In a “developmental embodiment” of a contest, the sequence of questions develops throughout the game, according to the answers given by a player. That is to say, answers which a contestant gives to earlier questions influence the selection of future questions presented to the contestant by the contest host. For example, a participant might select “North American geography” as the particular field relating to the first question. However, the participant's answer might alter the later questions within the test. For example, out of the first ten questions, five might relate to national parks, and five to historic cities and landmarks. If a participant answered all five national parks questions correctly, but failed to provide any correct answers relating to historic cities and landmarks, the host would select a second set of questions designed to further identify potential interests of the Internet user, such as interest in recreation vehicles, rappelling gear, rock climbing or mountain climbing equipment, back packing equipment, camera equipment, travel packages, climbing or camping tours, boating equipment, hunting or fishing equipment, resort areas related to these recreational activities. In contrast, if a participant got all five questions wrong about national parks, but all five questions correct about historic cities and landmarks, the host could select a second set of questions designed to further identify potential interest, such as particular time periods (revolutionary war, civil war, etc.), geographic preferences (north east United States, the southern or confederate states, etc.), food preferences (fish, beef), and the detail of knowledge of these matters (which may indicate a preference for a walking tour or a museum with a long lecture). Although the above development embodiment has been described in conjunction with a contest embodiment, the developmental embodiment can be equally applied to the search embodiment described herein.

Each question represents a “round.” A set of questions may comprise a single round, or multiple rounds. The redirection of the user's computer to a web site of potential interest may take place after any number of rounds, or any number of sets. The collection of questions from the first round to the time that the Internet user is redirected to a web site is herein known as a competition, contest or game in the contest embodiment, and a search exercise in the search embodiment. A contest embodiments may include an option wherein scores of multiple games are aggregated into a tournament score, analogous to the Tour de France, where there are individual winners of stages, but also, the aggregation of the stages combines to identify an overall winner.

The developmental embodiment can include “set-by-set” or “round-by-round” embodiments. In a “set-by-set” embodiment, after the final question of the previous set is answered, an entire next set of questions are identified. In a “round-by-round” embodiment, each new question is individually selected on the basis of previous answers. Hybrids of these two models are also envisioned. Assume, for example, that at the end of a set of questions, a next set of ten questions is identified. However, if after five of ten questions in the new set, the user has not indicated knowledge, interest, or skill, the host algorithm scrap the current set of questions and identifies a new question, or set of questions designed to identify web sites commensurate with the user's interests.

The developmental embodiment has the advantage of allowing the host to adjust the questions to the skill level, knowledge level, and/or interest level of a user. A limitation of the developmental embodiment, however, is that it does not allow individuals to compete against other persons in “direct” competition, where all are facing the same set of questions, but has the advantage of ‘leveling’ the playing field through what can essentially be deemed to be an automatic ‘handicapping’ system to allow people of lesser skill and knowledge an opportunity to compete with a greater likelihood of success against those of greater natural ability. The set-by-set embodiment can reduce a large starting field into multiple smaller competing fields, but retain a sense of direct competition. However, in search embodiments, or contest embodiments in which a contestant is competing against himself rather than a field of contestants, a round-by-round embodiment would not result in any perception of unfairness, or winnow down the field of competitors.

In a variation of the set-by-set embodiment, each subsequent set is selected by the host. In an alternative variation of the set-by-set embodiment, after a set is completed, the contestant is presented multiple categories, and allowed to select the category of the next set of questions, or change categories from which questions are to be drawn at any time. Contest scoring can nevertheless remain against the entire starting group, or could be reduced down to inter-player competition between persons who have selected the same category of questions.

In a fixed question embodiment, all participants would receive the same questions throughout the game.

In a contest embodiment, each contestant, or team of contestants is directed to various internet locations to identify information necessary to answer a test question, thus drawing the participant to view each sponsoring company's/individual's web site and to learn about their offering. In addition, various bonuses are offered on the sponsoring web site which draw the contestant further into the service/product offerings of that company and offer an additional opportunity to make the contestant learn about a third-party product and even visit the third-party's web site. Although the questions—tests—will appear to be delivered from that web site, they will rather be delivered from the operating company's servers. All interactions with the contestant will be logged for analysis and revenue generation with the sponsoring web sites and companies. The participating web clients may prepare informative web pages specifically designed to work in conjunction with the contest embodiment.

Because a purpose of the host is to educate Internet users about goods, services, or information provided by various Internet clients, the contest is preferably structured in a manner that maximizes actual learning by the Internet user. Since repetition is a key to learning, contest embodiments are envisioned that take place over several days or longer, thereby reinforcing the information gained by each contestant over a period of time. An internet client may prepare questions determined to educate a client about their goods, services or information, and submit these questions to the host for incorporation in a contest.

Revenue from clients may be collected on a per-click basis of participating users who access a web site prepared for a contest. Alternatively, revenue collected from clients may be based on actual purchases by clients, or the length of time a client spends on a client's web site. Statistics regarding length of stay, and user interaction on a clients web site will be retained by the host. These statistics may be used as a “selling point” to Internet Clients.

Embodiments are envisioned wherein the correct answers are made available to a user immediately after each answer is provided by the user. Alternatively, providing the the correct answers to an Internet user may be postponed until multiple questions have been answered. Similarly, embodiments are envisioned wherein a contestant is advised of his or her point total after each question, or, alternatively, wherein the score or point total is not disclosed or updated until multiple questions have been answered by the contestant.

Although the competition embodiment has been largely described in terms of multiple players competing against each other, embodiments are also envisioned wherein a player competes against “himself” in much the same way a pin-ball player would simply try to run-up the highest possible score, in effect, competing against himself.

The usefulness of the contest embodiment for a web site primarily dedicated to information can be appreciated by the following: A denomination desires to attract members for its local churches, to catechize, and to evangelize in general. They prepare a series of theological questions that direct the contestant to answers on their web site. In the process of testing his skill, the contestant is exposed to the theological beliefs, and the reasoning behind those beliefs, of a particular denomination. Whether or not he joins the church, it has accomplished its primary goal of exposing him to the gospel message, and reasons for believing it.

In another example, let's say Local Private College wants to step up its recruitment of incoming freshman. However, they find themselves competing for students against the better known, and better funded State University. They prepare a series of questions aimed at educating high school juniors and seniors. For example, a question could be:

What how much does the average graduating senior own in school loans?

State University?

Local Private College?

The answers to each of these questions may be multiple choice, a pull down menu, or fill in a text box, with a right answer being any answer within a certain range of money. The question can be structured such that the page is not submitted until an answer for both questions has been provided.

Upon entering the answers, the reader is automatically directed to a page on the Local Private College web site, comparing the loans and debts of the average graduate, the average length of time to pay off those loans, and how State University compares.

In an embodiment, a host icon, or contest icon, is configured to remains in front of the new URL of Local Private College.

Embodiments are envisioned wherein subsequent questions are displayed on a sequence of URL pages of Local Private College, with scoring and tracking done by the Internet host who is administering the contest.

Questions are preferably structured instruct the user in a cumulative manner. First, the debt at graduation can be discussed. In a next question, the employment and earning potential for Local Private Collage students can be compared with that of State University.

To enroll people to enter the contest, Local Private College may use any known technique, such as targeted advertising. This may include identifying parents of high school students through internet, or other targeted mediums. As discussed below, a demographic profile of each user will enhance the ability of the Internet Host to target meaningful candidates with notices of meaningful contests. If the demographic information indicated the home state of a parent, and information about children in the age range of 16 to 18 years old, targeted “notice” about the college contest could be effectively targeted to such a person. This is particularly true if a ping-module embodiment were adopted, as discussed further below.

Multiple advantages abound in the above method, compared with traditional advertising for college applicants. Firstly, the above sequence of questions about Local Private College (“contest”) requires thought, and deliberate engagement by the participant. A sign at the side of a road advertising Local Private College does not cultivate mental engagement of this nature. Secondly, the questions can be delivered on a timed basis over a period of time that a parent and child would be likely to select a school. The timing can therefore amplify the learning process intended by the contest questions.

In contrast to a “contest” embodiment, a “search embodiment” is utilized when an Internet user seeks to locate a URL site that offers some specific good, service, or information. The host presents questions to the Internet user. The answers provided by the Internet user are analyzed by the Host in order to identify one or more web sites matching the interests expressed by the user. Aspects of the search embodiment are similar in function to prior art search engines. No score or competitive standing is awarded. The questions and challenges presented to a user in a “search embodiment” need not be to the exclusion of known search engine technology. Rather, search engine technology may constitute a subset of the searching algorithms and methods used in a search embodiment. The sequence of questions in a search embodiment may include any combination of search term submissions, skill based multiple choice questions with an objectively correct answer, subject-need based multiple choice questions which allow user selection of answers relevant to the user's search, and skill based tests. The following sequence of steps is an example of a “search embodiment.”

In step 100, an internet client submits a URL site, and matching terms, to the host for inclusion in the contest, search, and targeted advertising embodiments. The internet client pays the host for the right to participate. In an embodiment, the internet client distinguishes whether it is principally an informational web site, or a commercial web site. This will assist the host algorithm in prioritizing the client's URL site compared to other web sites corresponding to a same answer or search term. If a web site is primarily an informational web site, the host algorithm will not consider frequency of commercial transactions in the prioritization. However, other metrics for prioritizing an informational web site are envisioned. For example, the average amount of time a user spends on an informational web site may be used to prioritize multiple web sites offered as solutions to the same terminal answer or search term.

In step 101, the user accesses the host web site. Alternatively, a menu or field linked to the host can be permanently displayed on the tool bar of a user's internet browser in a similar manner to existing search engines that are permanently linked to a browser, thereby allowing the Internet user to access the services of the Internet host without accessing the home page of the host.

In step 102, the user initiates a search request. The request may be initiated through submission of a search term in a manner similar to a search term being submitted to a search engine. Alternatively, the search may be initiated by selecting links from drop down menus (or static menus), alphabetical listings, etc.

In step 103, the algorithm determines if sufficient information was gathered in the initial search to allow redirect to a web site (or present a listing of URL links or web sites) wherein there is a high degree of likelihood that a user would be satisfied with the solution granted. If a search term were used to initiate a search, and a suitable (high probability) web site were identified on the first search effort, the process would essentially duplicate search prior art search engines. If more information is required before redirecting the user to a web site, or displaying a list of potential web sites, the process will continue to step 104.

It will be readily appreciated that current search engine algorithms are not principally designed to satisfy user demand. Rather, they are designed to maximize a search result ranking based, primarily on the optimization performed by the URL manager, such as meta tags, cross links, etc. Moreover, current search engines are a “one time” shot. If a prior art search engine does not present satisfactory results, a user must begin the search process from the beginning. Prior art search engines are not configured to cumulative combine the results of successive searches to “close in” on a consumer's need. They offer no opportunity to refine the request from among the “matches” presented by hyperlink. Rather, a new term must be submitted. As such, current search terms are not designed to have one search “standing on the results” of a previous search.

In contrast to prior art search engine technology, a unique feature of the present invention is that it involves successive search or matching attempts, wherein each successive submission considers not only the most recent submission of the Internet user, but all previous submissions by the Internet user related to the same search. As noted, these successive submissions may be in the form of a keyword (such as found in present search engines), multiple choice questions, selection of subjects from menus, etc. Steps 104 and following further illustrate this process.

If, in step 104, the host determines that the original search parameters of the Internet user are not sufficient to recommend a web site with a desired probability of customer satisfaction, then, in step 105, the host selects a first question, or a first set of questions, which is/are calculated to help direct the user to the most relevant web site. As discussed above, the question can be from among a multiple choice question, a word field (like a search term), or a skill question. Although the examples throughout this disclosure are described in terms of text questions, these examples are not intended to limit the appended claims, which envision alternative forms of questions. The alternative forms of questions may include, but are not limited to, audio questions in narrative format, audio skill questions such as identifying a musical composer, and video questions, which may include, but are not limited to, video gaming skills, identification of a famous work of art, identifying an object, person or place depicted in a photograph etc. In a contest embodiment, the questions may or not have only have a single correct answer. Similarly, in a search embodiment, the questions may or may not be limited to a single correct answer. In the multiple choice question presented in the example below, it is assumed that, in the initial question was a search term field, and that a user submitted the search terms, “travel, electronic equipment.” It is further assumed, for purposes of this example, that the host algorithm determined the best means of gathering information in the second round was the multiple choice question. In response, the host algorithm displays the following question on the computer screen of the user:

Are you looking for:

Power converters for converting voltage or frequency of foreign countries to that used domestically in the United States?

Power outlet adapters for plugging U.S. Power cords into wall outlets of foreign countries?

Cell phones that are compatible with foreign countries?

GPS devices with local maps of highways in foreign countries?

Modules with maps of foreign countries that can be downloaded into GPS devices?

Instructions for using GPS devices in foreign countries?

Electronic translation devices?

Other?

It will be appreciated by the rules of English grammar that an interrogative verb need not be presented to form a question. The above list, even without the interrogatory sentence, conceptually forms a question.

Answers to a question may include terminal answers, and non-terminal answers. Selection of a terminal answer will either redirect the Internet user's computer to a web site, or display a list of potential web sites on the computer screen of the Internet User. Selection of a non-terminal answer will not execute a redirect to a matching web site, or a listing of potential web sites. Rather, a non-terminal answer will result in the display of another question. The new question may be in the form of a multiple choice question with a single correct answer, a multiple choice question wherein the answers reflect user preference, or submission of a text term through a text field. The text field may be be used to submit a search term to a search engine, or may be used to submit an answer to a skill question requiring user submission of some specific term to yield a “correct” answer.

In step 106, the user submits the answer by striking the “enter” key, clicking on a designated icon or link, or some other appropriate response.

If, in step 107, the user selects one of the existing categories as the answer to his search, and, if the selected category is a terminal answer, then, in step 108, the algorithm would direct a user to an appropriate web site, or display a list of links to web sites representing a likely match to the Internet user's answer.

If, in step 107, the user selects a non-terminal answer (such as the word “other,”), the host program would recognize that the best answer had not been provided on the initial list, or the Internet user had not recognized the best answer among the options listed, and continue to step 109.

In step 109, the host algorithm presents a new question on the computer screen of the Internet user to further clarify the nature of the good or service sought by the Internet user. Let us assume, for example that the user who input “travel, electronic equipment” was seeking a travel alarm clock. This option is not presented on the above list of answers. As a consequence, the following question is presented to the user:

Are you looking for:

A travel alarm clock?

An electronic tooth brush or other electronic hygiene or grooming device?

A device configured to attach to a personal computer?

Other.

If, in step 110, the Internet user selected “a travel alarm clock,” (and, assuming, for purposes of example, that this answer were a terminal answer) then, in step 111, the host program would either redirect the Internet user to a web site featuring travel alarm clocks, or direct the Internet user to a screen display that included a variety of hyperlinks to web sites featuring travel alarms.

In step 111, if the user is directed to a page with a list of hyperlinks believed by the algorithm to satisfy the search of the user, in step 112, the host advantageously tracks users and monitors their ultimate selection and purchase of a good or service on one of the sites.

If, in step 113, the user purchases a travel alarm clock online, then in step 114, to determine if the good or service being purchased relates to the search, the host program will present the following question to the user's computer screen: “Is this the object you had in mind in the most recent search, or his this purchase unrelated to the search parameters you submitted?” The answer will enable the host algorithm to rank travel alarms to conform with the probability that an Internet user is interested in a travel alarm when a user provides specific answers, search terms, or category selections.

In step 115, the Internet user clicks on an appropriate answer.

In step 116, the answer is processed by the host to improve the accuracy of the system. According to an embodiment, the answer is processed by an artificial intelligence program that is configured to incorporate the selection by the user in the prioritization of potential web sites in future searches for a “travel alarm clock” or related terms. The user's answer will enable an artificial intelligence program to prioritize the various links that were presented on the Internet user's screen. Therefore, in step 116, if appropriate, the host program re-prioritizes the hyperlinks associated with a travel alarm clock. This can be performed by human agent, but is preferably performed, at least in part, by a digital program that maintains a correlation value between an answer (or search term or category) and URL sites corresponding to that search term. In an embodiment, an answer or search term may have one or more groups of URL links associated with the answer. The URL links matching an answer or search term may be ranked, and/or assigned a “matching value” based on a number of factors. 1) Does a URL site have the requisite products, services, or information to constitute a match? 2) When this group of URL sites have been presented to an Internet user, which has most frequently produced a “hit” or a “sale.” 3) Have they paid the host to participate? The cost of participation may be based on the number of products offered on the web site, variety of distinct products, gross annual sales, or other factors. Payment may also be on a “per click” basis. Placement among multiple qualifying URL sties may also be based on competitive bidding.

If, in step 113, the user does not purchase any item, then in step 117, the host program presents the following question and potential answers to the user:

Did you find the good or service you were seeking?

Yes, but I have elected not to purchase at the present time.

Yes, but I would like to survey other web sites featuring this article.

Yes, but not exactly the model or price I was seeking.

No, the web sites which I visited did not appear to have the object I was seeking.

In step 118, the host program uses the information provided in the above answer to modify a statistical data base that will govern the priority and ranking of web sites presented in future searches using the term “travel alarm clock” or similar answer or search terms. As in step 116, the statistical changes made to the data base may alter the web site to which future users are redirected, or the order of web sites presented as matches.

Self Programming Neural Network

In addition to altering the priority of URL links presented as preferred search solutions, the host program is also configured to monitor successive search terms entered by a user, and from these terms, generate successive questions. For example, each of the potential answers listed above in the second and third round of questions may have been added as potential answers in view of earlier failures of the algorithm to offer the answer sought by the Internet user, or the addition of new client web sites that qualify as matching. Accordingly, the host preferably employs a learning algorithm to improve the quality of the search results (or redirect results). The algorithm adds relevant URL sites, deletes irrelevant URL sites falling below a requisite level of relevance, and prioritizes URL sites if multiple URL sites correspond to a search term, category, or answer.

According to a feature of the host program, relevant search terms would also be cross-linked according to the statistical frequency with which they are submitted by the users. The process of adding new terms, formulating new questions, or cross linking terms, etc. may be performed exclusively by an artificial intelligence program, human review and programming, or a combination of both. In an embodiment, major changes recommended by the host program automatic are flagged for review by human agents to ensure that the web sites recommended by the automated program are relevant, and not a comical misuse of the language.

Online ID for Users

According to an embodiment, each participant is required to have an online ID to participate in a competition, and to “sign in” to the host with the online ID prior to commencing any competition or contest. In the process of issuing an online ID, demographic data about an individual contestant can be gathered. This data can then be taken into consideration in conjunction with answers provided by a user to more effectively redirect a user to a web site with a high probability of interest. In embodiments comprising multiple competitors, the number of participating players may, or may not be disclosed to all contestants and/or the public at large. Similarly, the on-line IDs of various contestants may be visible to each contestant, or concealed. The display of names creates other marketing opportunities, such as social networking web sites. Embodiments are envisioned wherein Internet users may contact other Internet users through the network.

Another advantage of requiring an online ID is that, in the event that a user purchases a new computer, the host does not need to begin compiling a data base for the user “from the ground up.” When a user signs in to compete in a game, or to search for a good or service, the aggregate data about the Internet user is available to assist in the most accurate search or redirect to the appropriate URL site.

In an embodiment, a synergy can be achieved by combining a “ping module” to the skill test/competition embodiment described above. In a mobile computing environment, laptop computers are easily carried about, and may access the web at any number of Internet Service Providers, including a home ISP, work ISP, cyber café ISPs, and ISPs any other variety of locations, from the home of a friend to a summer cottage to a hotel. Targeted advertising can easily be directed to a computer if a competitor is signed in with the host. But if a competitor is not signed in, a ping module notifies the host at regular intervals of the current address of a particular computer. Even if that computer is not signed with the host, targeted advertising may still be utilized of the host knows the identity of a computer, and the current location of a computer. A ping module, therefore, is configured to periodically “ping” the host from a user's computer, identifying the user's computer, and further identifying the location of the user at that moment. As used in this sense, the user's “location” represents any information necessary to direct information to that user over the internet, such as an ISP number). For targeted advertising to be fully exploited in a mobile computing environment, a ping-location module is essential.

Because multiple persons may use the same computer, the host algorithm analyzing user data for statistical correlates to goods and services preferably includes a process of determining whether a computer is used by a single user, or a multiple users. The easiest way to determine this is when a second gamer signs on to the host through the same computer as a first gamer. The gaming host is able to record that two separate IDs have competed from the same computer.

In an embodiment, the gaming host can present an onscreen question to a user, such as “Is this Joseph?” The presentation of this question can be time or event driven. An example of a time driven trigger would be a 30 minute period of inactivity on a computer. An event driven trigger might be an analysis of internet surfing that appears inconsistent with the profile of a particular user.

The accumulation of data relating to a contestant can be further enhanced by tracking the web surfing habits of a user. Tracking can be done locally through the accumulation of “cookies” in a user's computer, or may be performed centrally at a data center controlled by the host. Multiple advantages inure from central data tracking. First, the internet user data will not be expunged every time the user erases the “cookies” that have accumulated in his computer. The record of internet URL sites visited by a user can be included in any statistical analysis seeking to identify a correlation of user interest to particular products and services, thereby increasing the accuracy (and likelihood of user interest) in a good or service appearing in targeted advertising, or in a good or service described on a web site to which a user might be redirected.

Embodiments are envisioned in which “sponsoring” web sites participate on a fee basis. Continuing with the previous example of a travel alarm clock and other electronic travel items, if a sponsoring web site had a large inventory of such electronic goods, embodiments are envisioned wherein the URL provider could even recommend leading questions to “winnow down” the field. Alternatively, embodiments are envisioned wherein a URL provider pays an initialization fee to the host with instructions sufficient to allow the programmer to formulate the question paradigms. In yet an alternative embodiment, an artificial intelligence program could assist in developing the questions and answers or terms that match a particular good or service. In an embodiment, the categories for goods described in the U.S. Patent Office classification system or the international classification system can be used as a template for identifying goods and services that should be accessible through a series of questions and answers, search terms, or skills. The process of receiving payment to include the goods and services of a sponsoring web site in order to redirect users to those URL sites significantly reduces the likelihood of “junk” answers so often presented by search engines.

Within the foregoing description, many specific details commonly understood by those skilled in the art have not been recited so as to not needlessly obscure many of the essential features of the present invention. In other instances, some non-essential details have been described in conjunction with specific embodiments of the claimed invention to better enable those skilled in the art to make and use the claimed invention. Accordingly, these specific examples are not intended, and should not be construed as limiting the full range of applications. On the contrary, it will be readily apparent to one skilled in the art that the claimed invention may cover alternative embodiments and equivalent methods without departing from the spirit and scope of the foregoing description in view of the claims appended hereto.

What is claimed as new and desired to be protected by Letters Patent, as set forth in the appended claims is:

1. A method of directing a user to a web site of interest through the operation of an Internet host, the method comprising the steps:
displaying, a multiple choice question and a plurality of potential answers on a computer screen of an Internet user;
receiving from the Internet user a first answer to the multiple choice question; and
redirecting the Internet user to a target web site statistically correlated to the first answer.

2. The method according to claim 1, wherein at least some of the first answer is a terminal answer.

3. The method according to claim 2 wherein selection of a terminal answer by an internet user directly results in a redirect of the Internet user's computer screen to a target web site.

4. The method according to claim 2 wherein selection of a terminal answer by an Internet user is immediately followed by the step of displaying a list of web sites on the Internet user's computer screen.

5. The method according to claim 1 wherein at least some of the potential answers to the multiple choice question are non-terminal answers.

6. The method according to claim 4, further comprising the step:
displaying a list of qualifying web sites on a computer screen of an Internet user in response to the first answer; and,
selecting the target web site from among the plurality of qualifying web sites, wherein the step of redirecting is governed by the step of selecting the target web site.

7. The method according to claim 6, wherein a host data base comprises a plurality of terminal answers including the first answer, and wherein each terminal answer is associated with at least one qualifying web sites.

8. The method according to claim 7, wherein a list of qualifying web sites displayed on the computer screen of the Internet user is arranged according to a relative priority of the qualifying web sites in the list.

9. The method according to claim 8, wherein a relative priority of a particular web site among the qualifying web sites is governed, at least in part, by a frequency with which the step of redirecting is directed to the particular web site.

10. The method according to claim 8, wherein a relative priority of a particular web site among the qualifying web sites is governed, at least in part, by a frequency with which a user executes a commercial transaction from a web site in response to a redirect by the Internet host.

11. The method according to claim 6, wherein an inclusion of a web site among the qualifying web sites is governed, at least in part, by payment received by the Internet host on behalf of a web site.

12. The method according to claim 2 further comprising the steps:
displaying a first preliminary question prior to the step of displaying the multiple choice question; and
receiving from the Internet user a non-terminal answer to the first preliminary question.

13. The method according to claim 12, wherein the first preliminary question comprises a multiple choice question.

14. The method according to claim 13, further comprising the steps:
comparing the non-terminal answer from the internet user regarding the first preliminary question to a correct answer;
increasing, by at least one point, a numerical score of the Internet user if the answer is correct; and
withholding any points from the Internet use if the answer is incorrect; and
deducting any points based on ‘failure’ to provide the correct response in an acceptable time.

15. The method according to claim 12, wherein the first preliminary question comprises a text field for submission of a text answer by Internet user.

16. The method according to claim 15, further comprising the steps:
comparing the text answer to a correct answer stored by the Internet host; and
increasing, by at least one point, a numerical score of the Internet user if the answer is correct; and
withholding any points from the Internet use if the answer is incorrect.

17. The method according to claim 3, wherein the first answer is a terminal answer.

18. The method according to claim 15 wherein a term in the text field first preliminary question comprises a search term, and wherein submission of the term in the text field engages a search engine searching for corresponding terms terms.

19. The method according to claim 18 wherein the corresponding terms are selected from among terms stored in a host data base.

20. The method according to claim 2 further comprising the steps:
accessing a menu comprising a list of subjects; and
selecting a subject from the menu.

21. The method according to claim 20 wherein the subjects comprise purchasable goods.

22. The method according to claim 20 wherein the subjects comprise purchasable services.

23. The method according to claim 1, further comprising the steps:
collecting personal information from the Internet user; and,
analyzing the personal information about the Internet user with an Internet host application.

24. The method according to claim 23, wherein a selection of a question presented to the Internet user is based, at least in part, on the personal information collected from the Internet user.

25. The method according to claim 23, wherein a selection of the target web site is based, at least in part, on to the personal information collected from the Internet user.

26. The method according to claim 23, wherein a selection of the target web site is based, at least in part, on answers by the Internet user for at least two questions.

27. The method according to claim 6, further comprising the steps:
collecting personal information from the Internet user; and,
analyzing the personal information about the Internet user with an Internet host application
wherein a selection of a web site for inclusion in the list of qualifying web sites is based, at least in part, on to the personal information collected from the Internet user.

28. The method according to claim 6, wherein a selection of a web site for inclusion in the list of qualifying web sites is based, at least in part, on answers by the Internet user for at least two questions.

29. A method according to claim 1 further comprising the steps:
displaying, a multiple choice question and a plurality of potential answers on a computer screen of an Internet user;
receiving from the Internet user a first answer to the multiple choice question; and
redirecting the Internet user to a target web site statistically correlated to the first answer.

30. The method according to claim 1, further comprising the steps:
submitting to the host a list of goods or services offered by a client;
storing the list of goods or services in the host data base;
correlating at least some of the goods or services to a trigger; and,
receiving payment from the client to the host.

31. The method according to claim 30, wherein the trigger is a question.

32. The method according to claim 30 wherein the trigger is a category.

33. The method according to claim 30 wherein the trigger is a search term.

34. The method according to claim 31 wherein the question is drafted by the client and submitted to the host.

35. The method according to claim 1 further comprising the step of offering award points to the Internet user, wherein the award points are based, at least in part, on a correct answer to the multiple choice question.

36. The method according to claim 35, wherein a number of award points awarded to an Internet user is governed, at least in part, by a length of time it takes an Internet user to respond to the multiple choice question.

37. The method according to claim 35, further comprising the step of providing clues to the Internet user relating to the correct answer.

38. The method of claim 37 wherein the clues include links to URL addresses of at least one client.

39. The method of claim 38, further comprising the step by a client of preparing a URL site with content relating to a question which may be presented to a user by the Host.
